(19) United States
(12) Patent Application Publication
(10) Pub. No.: US 2004/0033022 A1
(43) Pub. Date: Feb. 19, 2004

(54) Laser module for optical transmission systems and method for stabilizing an output wavelength of a laser module

(76) Inventors: Hans-Ludwig Althaus, Lappersdorf (DE); Helmut Albrecht, Munchen (DE); Manfred Rothhardt, Kunitz (DE); Martin Becker, Jena (DE)

Correspondence Address: LERNER AND GREENBERG, P.A., POST OFFICE BOX 2480, HOLLYWOOD, FL, 33022-2480, US

(21) Appl. No.: 10/642,544

(22) Filed: Aug. 15, 2003

(30) Foreign Application Priority Data
Aug. 15, 2002 (DE) 102 37 695.6

(51) Int. Cl. G02B 6/34

(52) U.S. Cl. 385/37

(57) ABSTRACT

A laser module can be used with optical transmission systems and a method stabilizes an output wavelength of the laser module. Devices are provided for stabilizing an output wavelength of the laser module; the devices have a measurement apparatus for measuring the photon density within the resonator, an adjustment apparatus for adjusting the effective optical path length of the resonator, and a control apparatus that, based on a comparison between different values of the photon density at the different effective optical path lengths of the resonator, produces control commands to the adjustment apparatus to adjust the effective optical path length of the resonator to equal the emitted output wavelength to a desired wavelength. The wavelength of a semiconductor laser can be set precisely to a desired wavelength irrespective of the age and ambient temperature.

### BACKGROUND OF THE INVENTION

### FIELD OF THE INVENTION

The invention relates to a laser module for optical transmissions systems, and to a method for stabilizing an output wavelength of a laser module. Corresponding laser modules are suitable in particular for use in WDM- (Wavelength Division Multiplex), DWDM- and CWDM (Dense and Coarse Wavelength Division Multiplex) systems.

Laser diodes with what is referred to as distributed feedback are known which, and in contrast to laser diodes with a Fabry-Perot resonator do not provide multimode emissions but monomode emissions, owing to the frequency-selective feedback. In this context, DBR (distributed Bragg reflector) lasers are known in particular, in which a Bragg reflector is disposed outside the normal active oscillation area. This is a structure with a periodic disturbance, the Bragg interference grating, which reflects an electromagnetic wave on a frequency-selective basis; see Reinhold, Paul: Optoelektronische Halblei terbauelemente [Optoelectronic semiconductor components], Stuttgart 1992, pages 203-204. J. M. Hammer et al.: “Single-Wavelength operation of the hybrid-external Bragg-reflector-wavelength laser under dynamic conditions”, Applied Physics Letters, Vol. 47, No. 3, August 1985, pages 183-185, discloses the Bragg reflector being included in a glass waveguide, which is optically coupled to a semiconductor laser so that an external resonator is produced. A semiconductor laser is formed with frequency selective feedback. This advantageously makes it possible to define the specific wavelength of the light within certain limits independently of the active laser source that is used, by the passive fiber Bragg grating and its grating constant. Thus, owing to the frequency-selective reflection, the fiber Bragg grating supports only a narrow laser wavelength range.

A fiber Bragg grating includes a grating structure in an optical waveguide, which is produced by periodic modulation of the refractive index in the fiber core. The grating is included in an optical fiber, for example, by illuminating a point on the fiber with ultraviolet radiation or by using a phase mask, which produces an interference strip pattern in the optical fiber. Conventional methods for producing a fiber Bragg grating are described in K. O. Hill et al.: “Fiber Bragg Grating Technology Fundamentals and Overview”, Journal of Lightwave Technology, Vol. 15, No. 8, August 1997, pages 1263-1276.

Laser modules for optical transmission systems produce optical signals at one or more wavelengths that, in the case of channel positions that comply with recommendations of the International Telecommunications Union (ITU) each form one information channel. The ITU recommendations for WDM, DWDM, and CWDM systems in this case define both the absolute position of the wavelengths and the wavelength pattern (channel separations). It is therefore necessary to avoid with high precision changes in the wavelength (and preferably in the output power as well) of the laser modules that are used.

In the case of laser modules with an external resonator using a fiber Bragg grating, the range of wavelengths that are emitted from the semiconductor laser is constrained by the fiber Bragg grating. However, the emitted wavelength of the laser module must not vary in the course of the life of the module. Furthermore, the temperature of the semiconductor laser must be kept constant when the ambient temperature varies, since any change to the laser temperature leads to a change in the wavelength, since the refractive index of the active material of a semiconductor laser is dependent on the temperature. Stabilization of just the temperature of the laser, as is known per se, cannot take account, however, of any ageing-dependent changes in the laser characteristics, and is therefore not sufficient to comply with the strict criteria from the ITU with regard to the absolute position of the channels.

### SUMMARY OF THE INVENTION

It is accordingly an object of the invention to provide a laser module for optical transmission systems and a method for stabilizing an output wavelength of a laser module that overcome the hereinafore-mentioned disadvantages of the heretofore-known devices of this general type and that set the wavelength of the semiconductor laser with high precision to a desired wavelength, in particular to the central wavelength of a fiber Bragg grating, irrespective of the age and ambient temperature.

With the foregoing and other objects in view, there is provided, in accordance with the invention, a laser module for optical transmission systems. The laser module includes a laser diode, an optical resonator, an optical waveguide, and a stabilizer. The laser diode emits light at an emitted output wavelength. The optical resonator connects to the laser diode and has a highly reflective mirror surface and an adjustable effective optical path length and a photon density as a function of the effective optical path length. The optical waveguide has a Bragg grating receiving the light from the laser diode. The stabilizer stabilizes the emitted output wavelength and has a measurement apparatus for measuring the photon density within the resonator, an adjustment apparatus for adjusting the effective optical path length of the resonator, and a control apparatus comparing the photon density at different effective optical path lengths of the resonator and producing control commands to the adjustment apparatus in order to adjust the effective optical path length of the resonator to equal the emitted output wavelength to a desired wavelength.

With the objects of the invention in view, there is also provided a method for stabilizing an output wavelength of a laser module for optical transmission systems. Step a) of the method is providing a laser module as described in the previous paragraph. The next step is b) measuring the photon density within the resonator at a first effective optical path length of the resonator. The next step is c) changing the effective optical path length of the resonator. The next step is d) measuring the photon density within the resonator at a second effective optical path length of the resonator. The next step is e) comparing the two measured photo densities. The next step is f) adjusting the effective optical path length of the resonator based on the comparing step, with the effective optical path length of the resonator being changed depending on the comparing step. The next step is g) repeating steps b) to e) until the emitted output wavelength is equal to a desired wavelength.

On this basis, the laser module according to the invention is distinguished by a stabilizer of an output wavelength of the laser module. The stabilizer has a measurement apparatus for measurement of the photon density within the resonator, an adjustment apparatus for adjustment or variation of the effective optical path length of the resonator, and a control apparatus, with the latter producing, on the basis of a comparison between different values of the photon density for different effective optical path lengths of the resonator, control commands to the adjustment apparatus to adjust the effective optical path length of the resonator, such that the emitted output wavelength is equal to a desired wavelength.

The method according to the invention is distinguished; in that, the photon density within the resonator is first measured at a first effective optical path length of the resonator. Then, the effective optical path length of the resonator is changed and the photon density within the resonator is measured once again at the changed effective optical path length of the resonator. The measured photon densities are then compared, in particular being subtracted from one another, and the effective optical path length of the resonator is then set on the basis of the comparison carried out, with the effective optical path length either being lengthened or shortened as a function of the comparison carried out. These steps are repeated until the emitted output wavelength is equal to a desired wavelength. The desired wavelength is preferably the central wavelength of the Bragg grating or a wavelength close to the central wavelength, so that the wavelength is within the respective specific channel width and maintains the respective specific channel separation.

The present invention is thus based on the idea of setting and stabilizing the output wavelength of a laser by iterative measurement of the photon density and adaptation of the effective optical path length of the optical resonator based on successive measurements. This results in active regulation to a desired wavelength, preferably the central wavelength of the Bragg grating. The stabilization of the wavelength also prevents sudden mode changes in the laser and ensures stable operation of the laser.

The stabilization according to the invention of the output wavelength compensates not only for changes in the laser characteristics which are related to ageing of the laser diode but also changes caused by a change in the ambient temperature or other influences (for example mechanical stresses). The invention in this case makes use of the knowledge that the photon density of a semiconductor laser (for example measured via the current of a monitor diode), plotted as a function of the output wavelength of the semiconductor laser, has a maximum at the central wavelength of the Bragg grating. Away from the maximum, the difference between the photon densities for two different effective optical path lengths of the resonator (and hence different output wavelengths) is not equal to zero, and it is possible to use the mathematical sign of the difference value to deduce the side of the maximum on which the present output wavelength is currently located.

The known relationship between the photon density of a semiconductor laser and the output wavelength can also, however, in principle be used for regulation at a value other than the central wavelength of the Bragg grating.

It should be mentioned that the term “photon density” is in each case identical to the term “light intensity”. “Measurement of the photon density” means that a value is measured whose magnitude is dependent on the photon density in the resonator. This also includes measurements that do not produce the photon density directly, but only allow the photon density to be determined indirectly from them.

With regard to the terminology used, it should also be mentioned that the effective optical path length of the resonator is defined as the geometric distance between the two reflectors of the optical resonator multiplied by the refractive index n of the material in the respective resonator section. A change in the effective optical path length of the resonator leads to the resonance condition being satisfied for other wavelengths, so that the laser line of the output light is shifted.

In general, in this context, it should be noted that standing waves for a large number of discrete wavelengths are formed within the resonator for a specific effective optical path length of the resonator, and these represent the individual axial modes of the resonator. However, only one of these modes is amplified owing to the frequency-selective feedback by the Bragg grating. However, the Bragg grating also has a certain spectral extent, and the laser line can move within the corresponding range. The laser line can be shifted to any desired point in the spectral width of the Bragg grating by varying the effective optical path of the resonator. In this case, it is worthwhile making a laser line of the output light coincident with the central wavelength of the Bragg grating, since the Q-factor of the laser is at its best at this wavelength. Furthermore, this value is particularly accessible for regulation purposes since the photon density in the optical resonator reaches a maximum at the central wavelength.

In principle, the Bragg grating can be included in any desired optical waveguide, for example even in a planar waveguide structure. The waveguide in which the Bragg grating is included is preferably a glass fiber, in particular a single-mode glass fiber. For this situation, the Bragg grating is referred to as a fiber Bragg grating. The glass fiber is preferably connected via a glass fiber connected to a housing in which the laser diode is disposed.

The apparatus for adjustment to the effective optical path length of the resonator is used, as explained, to spectrally shift the laser line of the output light to a desired wavelength. The adjustment apparatus may be configured in a number of ways.

In a first preferred embodiment, the adjustment apparatus has a device for longitudinally shifting the optical waveguide with the included Bragg grating. Since the Bragg grating represents one mirror surface of the resonator, the effective optical path length in this configuration variant is adjusted by adjusting the geometrical distance between the two mirror surfaces. In this case, it is important for the light from the laser diode to be coupled into the fiber via free-beam optics with suitable coupling optics.

In a second preferred embodiment, the adjustment apparatus has a device for heating or cooling the laser diode. In a third preferred embodiment, the laser diode is heated indirectly by changes to the operating current of the laser diode. In both of the last-mentioned variants, the effective optical path length is adjusted or adapted by appropriately changing the temperature-dependent refractive index of the semiconductor crystal of the laser diode. The abovementioned refinements of the adjustment apparatus for adjustment of the effective optical path length of the resonator should be regarded only as being by way of example. In principle, the phase of the light in the resonator can be shifted and the effective optical path length of the resonator can be adjusted in any other way, as well.

In one preferred refinement, the measurement apparatus has a monitor diode, which is disposed adjacent the highly reflective mirror surface of the optical resonator. The light that escapes through the highly reflective mirror surface or facet of the optical resonator is in this case passed to the monitor diode. This allows the photon density that exists in the laser to be measured.

Alternatively, the photon density can also be measured via the voltage across the laser diode when the laser operating current is constant. The voltage on a laser diode is influenced primarily by the band edge of the semiconductor laser, the intrinsic resistance of the semiconductor material and, in laser operation, the photon density as well. The stimulated emission for laser operation is thus assisted by photons in the semiconductor chip. More electrons can pass through the pn junction at a higher light intensity for the same voltage. The intrinsic resistance of the semiconductor laser thus decreases as the light intensity in the resonator increases. Thus, when the laser operating current is constant, it is possible to use the voltage across the semiconductor laser to indirectly deduce the photon density in the resonator.

The control apparatus is preferably a part of a control loop that regulates the output wavelength of the laser module at a desired wavelength. The photon density is in this case measured iteratively, and the control apparatus in each case passes a control command to the adjustment apparatus, in order to adjust the effective optical path length of the resonator, based on the difference between two successive measurements.

The laser diode is preferably a Fabry-Perot semiconductor laser, one of whose facets is formed by the highly reflective mirror surface of the optical resonator. The other, front facet of the Fabry-Perot semiconductor laser is preferably coated with a nonreflective layer, which preferably has a residual reflection of less than 0.1%. This allows parasitic resonances at the optical resonator to be suppressed. Light is emitted via the front facet to the Bragg grating, and is received from it, so that reflection on this facet is undesirable.

In one preferred refinement of the invention, the module has coupling optics between the optical waveguide and the laser diode. The coupling optics preferably have a high refractive index coupling lens with a focal length of preferably less than one millimeter. The coupling lens is, in particular, a spherical or aspherical silicon lens, a GaP lens, an SiC lens or a lens composed of some other suitable high refractive index optical material (organic or inorganic). A particularly short focal length glass lens, in particular an aspheric glass lens or a gradient index lens, may also be used.

The optical waveguide is preferably a single-mode glass fiber. The end of the glass fiber is in this case preferably coated with a nonreflective coating or is slightly inclined from the normal of the axis, in order to avoid undesirable feedback to structures other than the further Bragg grating. This also applies to the coupling optics.

The Bragg grating is preferably located in the immediate vicinity of the laser diode. In other words, the length of the optical resonator is preferably as short as possible, so that the frequency of revolution of the light is higher than a desired modulation frequency of the module. Otherwise, it would be impossible to transmit information on the optical information channel provided by the laser. In particular, the length the optical resonator is preferably less than ten millimeters.

The Bragg grating, which is part of the optical resonator, naturally has a certain spectral extent, within which the laser line of the emitted laser light can move. At the edges of this range, the laser will either cease operation or will make a sudden mode change, that is to say the laser will start to oscillate on a different laser line within the spectral width of the Bragg grating. The precise precision of the wavelength is, according to the invention, set by a device of the adjustment apparatus based on control commands from the control apparatus.

With regard to the control commands that are emitted by the control apparatus to the adjustment apparatus in order to adjust the effective optical path length of the resonator, it should be noted that these may be of such a nature that the effective optical path length of the resonator is always lengthened or shortened by a predetermined value. Since an adjustment is repeated iteratively until a desired wavelength is set, this procedure will sooner or later lead to selection of the desired wavelength.

If the aim is to keep the number of iterations as small as possible, the optical path length of the resonator may also be lengthened or shortened by an amount which depends on the result of the comparison of the measured photon densities. If the photon densities for two different effective optical path lengths of the resonator differ, for example, by a large amount, then the optical path length can likewise be lengthened or shortened by a large amount. In a corresponding manner, the optical path length is changed only by a small amount if the measured photon densities differ only slightly.

Other features that are considered as characteristic for the invention are set forth in the appended claims.

Although the invention is illustrated and described herein as embodied in a laser module for optical transmission systems and a method for stabilizing an output wavelength of a laser module, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a partially schematic and partially diagrammatic view showing a laser module according to the invention for optical transmission systems and having a fiber grating laser and an output wavelength stabilization;

FIG. 2 is a partially schematic and partially diagrammatic view showing a basic configuration of a fiber grating laser;

FIG. 3 is a partially schematic and partially diagrammatic view showing two measurement apparatuses for measuring the photon density within the resonator of a fiber grating laser;

FIG. 4 is a partially schematic and partially diagrammatic view showing a first embodiment of an adjustment apparatus for adjusting an effective optical path length of a resonator of a fiber grating laser, the adjustment apparatus having a heating or cooling element;

FIG. 5 is a partially schematic and partially diagrammatic view showing a second embodiment of an adjustment apparatus for adjusting the effective optical path length of the resonator of the fiber grating laser, the adjustment apparatus having a device for active regulation of the operating current of the fiber grating laser;

FIG. 6 is a partially schematic and partially diagrammatic view showing a third refinement of an adjustment apparatus for adjusting the effective optical path length of the resonator of a fiber grating laser, in which the adjustment apparatus has a device for shifting one fiber end;

FIG. 7 is a graph plotting reflection coefficients of a fiber Bragg grating as a function of the wavelength;

FIG. 8 is a graph plotting a monitor diode current of a monitor diode associated with a fiber grating laser as a function of the wavelength;

FIG. 9 is a graph plotting the power of the light power of a fiber grating laser that is input into an optical waveguide as a function of the wavelength;

FIG. 10 is a graph plotting the voltage across the laser diode of a fiber grating laser when the laser operating current is constant as a function of the wavelength;

FIG. 11 is a graph plotting the wavelength/operating current characteristic of a fiber grating laser without active wavelength stabilization;

FIG. 12 is a graph plotting the wavelength/operating current characteristic of a fiber grating laser with active wavelength stabilization;

FIG. 13 is a graph showing the output wavelength of a fiber grating laser as a function of the temperature of the laser without the use of wavelength stabilization; and

FIG. 14 is a graph showing the output wavelength of a fiber grating laser as a function of the temperature with wavelength stabilization being used.

### DESCRIPTION OF THE PREFERRED EMBODIMENTS

Referring now to the figures of the drawings in detail and first, particularly to FIG. 1 thereof, there is shown a laser module for optical transmission systems having a configuration for stabilization of the output wavelength of the laser module at a desired wavelength.

The laser module has a semiconductor laser 1 which, together with a fiber Bragg grating 5 that is included in a glass fiber 4, forms an optical resonator. A coupling element (coupling optics) 8, which is used for matching the light emitted from the semiconductor laser 1 to the aperture of the glass fiber 4, is in this case disposed between the semiconductor laser 1 and the glass fiber 4.

The semiconductor laser 1 has an associated measurement apparatus 2 for measurement of the photon density within the optical resonator. A control apparatus 6 and an adjustment apparatus 7 are also provided and together with the measurement apparatus 2 form a control loop.

The measurement apparatus 2 is used for measurement of the photon density within the optical resonator, which is provided by the semiconductor laser 1 and the fiber Bragg grating 5. The photon density may be measured in various ways, as will be explained in the following text.

The adjustment apparatus 7 is used for adjustment of the effective optical path length Δeff of the optical resonator. In this case, the laser wavelength is set via the effective optical path length of the resonator, and is produced by the optical resonator. The effective optical path length of the resonator can likewise be adjusted in various ways, as will be explained in the following text.

The control apparatus 6 produces control commands to the adjustment apparatus 7 such that the effective optical path length Δeff of the optical resonator is set such that the emitted output wavelength of the semiconductor laser 1 is equal to a desired wavelength.

The target variable of the regulation process is thus the effective optical path length Δeff of the optical resonator, which in turn governs the wavelength of the laser light which is emitted from the semiconductor laser 1. The controlled variable is the difference or some other comparison between different values of the photon density for different effective optical path lengths of the resonator.

Thus, first of all, the photon density I(n) is measured for a first effective optical path length Δeff(n). The control apparatus 6 then emits a control signal to the adjustment apparatus 7 to change the effective optical path length of the resonator. The photon density I(n+1) is then measured once again within the resonator with the changed optical path length Δeff(n+1). The measured photon densities I(n) and I(n+1) are compared with one another, in particular being subtracted from one another and, depending on the comparison carried out, a control command is passed to the adjustment apparatus 7 in order either to lengthen or to shorten the effective optical path length of the resonator. The photon density is then measured once again, and is compared with the previous value of the photon density. This iterative process is carried out until the emitted output wavelength of the semiconductor laser 1 is equal to a desired wavelength, in particular equal to the central wavelength of the fiber Bragg grating 5.

For this purpose, provision is preferably made for the controlled variable, that is to say the difference between the values of the photon densities for two successive effective optical path lengths of the optical resonator, to be regulated at zero or at a small value less than ε. If the difference is regulated at zero, this represents one maximum of the photon density in the optical resonator.

As will be explained in the following text, one maximum of the photon density actually occurs, however, at the central wavelength of the Bragg grating 5 of the optical resonator. Regulation such that the photon density is a maximum in the semiconductor laser 1 thus automatically leads to the output wavelength of the semiconductor laser 1 being set to the central wavelength of the Bragg grating. This is preferably chosen such that it is equal to the wavelength of a wavelength channel of a WDM, DWDM, or CWDM system, in accordance with the ITU recommendations. The described laser module thus allows the output wavelength of the laser module to be regulated or set at a desired wavelength. In this case, it is possible by continuous regulation or by a regulation cycle at predetermined time intervals to calibrate the laser wavelength continually and, in the process, also in particular to take into account and to compensate for fluctuations which result from the age of the semiconductor laser. The described regulation process in this case compensates for all the influences on the output wavelength of the laser.

It should be mentioned that the positions of the individual measurement points are preferably so close to one another that the difference between the spectral positions of the laser lines that result from this is considerably less than the range stabilized by the fiber Bragg grating 5. It is possible to use the mathematical sign of the difference that is formed to determine whether the optical path length in the resonator must be shortened or lengthened in order to shift the laser line spectrally to the central wavelength λ_{BRAGG} of the fiber Bragg grating 5.

The effective optical resonator length is shifted based on the difference between the photon densities or intensity values, such that the laser line moves spectrally closer to the central wavelength of the fiber Bragg grating 5. In this case, the magnitude of the shift may be chosen such that the laser line approaches as close as possible to the central wavelength of the fiber Bragg grating after the effective optical path length has been changed. The adjustment of the effective optical path length of the resonator can thus optionally be carried out by a value which is dependent on the measured different between the photon densities.

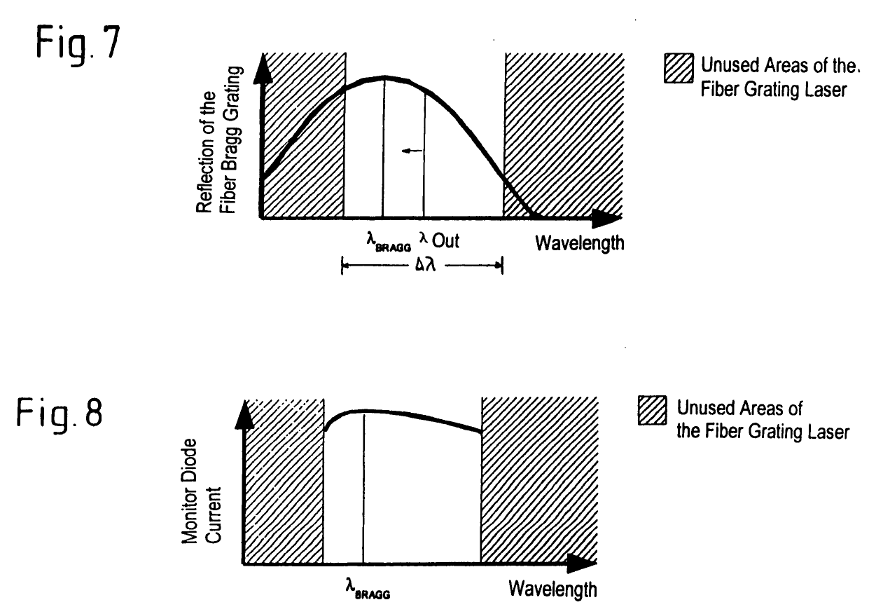

The described regulation process need not necessarily be carried out at the central wavelength of the fiber Bragg grating 5 but may also be carried out at a value other than this. FIG. 7 shows the reflection coefficient of a fiber Bragg grating as a function of the wavelength. The fiber Bragg grating 5 has a central wavelength λ_{BRAGG}. At the same time, it has a certain spectral width Δ80 within which monomode laser operation is possible. The current laser line λ_{OUT} is governed by the effective optical path length Δeff of the optical resonator, and can be shifted within the spectral range Δλ by the adjustment apparatus 7.

As explained, the output wavelength is in this case preferably shifted to the central wavelength λ_{BRAGG}. In principle, however, the wavelength can also be shifted to some other value within the spectral window Δλ, for example if, owing to manufacturing tolerances, the central wavelength does not correspond to the wavelength of a desired channel in accordance with the ITU recommendations for WDM or DWDM channels. In this case, the regulation process in the control loop shown in FIG. 1 is, for example, carried out in such a way that the difference between two successive photon densities is regulated at a specific value.

Those areas in FIG. 7 that are shown shaded represent the unused areas of the laser. If the output wavelength reaches this area, the laser will either cease to function or will make a sudden mode change, that is to say it will start to oscillate on a different laser line within the range Δλ.

Since the semiconductor laser 1 has an optical resonator with an external mirror surface (the fiber Bragg grating 5) in an optical fiber, it is also referred to as a fiber grating laser.

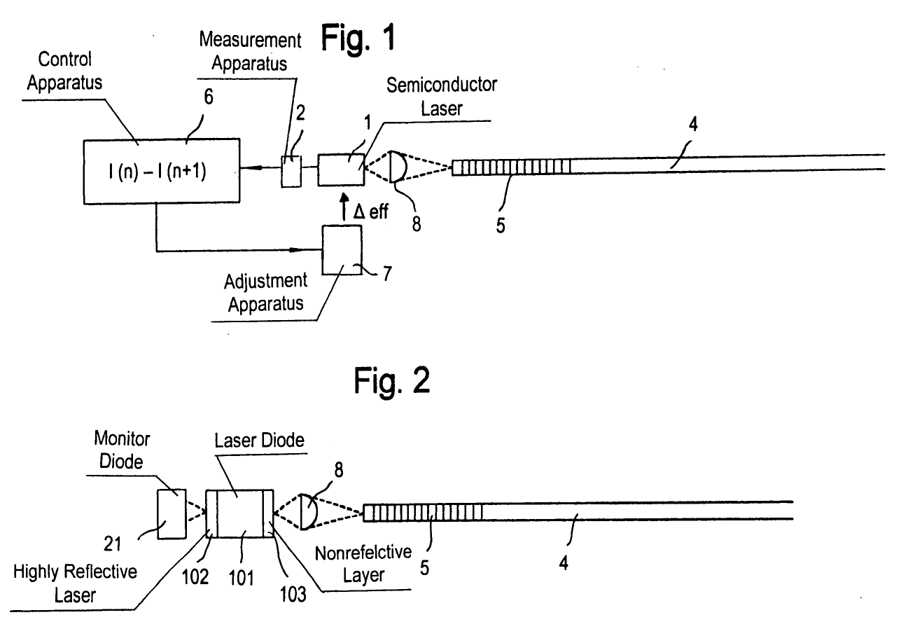

FIG. 2 shows one typical fiber grating laser in more detail. In addition to the components already mentioned in FIG. 1, this figure shows the laser diode 101, a highly reflective laser 102 on the rear facet and a nonreflective layer 103 on the front facet of the semiconductor laser 1, as well as a monitor diode 21. The highly reflective facet 102 of the laser and the fiber Bragg grating 5 form the optical resonator of the laser. The nonreflective coating 103 has a residual reflection of preferably less than 0.1%, and is used to suppress parasitic residual reflections on the semiconductor crystal.

The coupling unit 8, which is in the form of a highly refractive index lens, is used for matching the aperture of the semiconductor chip 1 and of the glass fiber 4. The light is introduced into the glass fiber 4 via the coupling unit 8 from the side with the nonreflective coating. The end of the glass fiber 4 and the lens surfaces are, in this case, preferably either likewise coated with a nonreflective coating or are slightly inclined from the normal of the axis of the glass fiber 4, in order to prevent reflections from the fiber end (not shown). The Bragg grating 5 is, as shown, disposed in the immediate vicinity of the laser diode 1. The current within the laser diode can be changed quickly in order to keep the circulation time of the light in the laser system short and the light intensity in the laser [lacuna].

A small proportion of the laser light is output through the highly reflective coating 102 and is detected by the monitor 21. Since the highly reflective coating 102 of the semiconductor laser allows the light to pass with equal intensity at all the wavelengths that are used by the laser, the monitor diode 21, which is coupled to it directly, determines the light intensity within the optical resonator.

If the current through the semiconductor chip is constant, the photon density in the resonator can optionally also be measured by the voltage that is applied to the semiconductor chip, as will be described in the following text.

It should also be noted that the front facet 103 of the laser 1 can also be provided with a slight tilt angle with respect to the laser axis in order to prevent parasitic backward reflections. As a further option, the light path in the semiconductor laser can be bent slightly, likewise in order to minimize reflections.

The semiconductor laser is preferably disposed in a TO can (TO=Transistor Outline) or in an SMT package (SMT=Surface Mount Technology), to which the optical fiber 4 is connected, with the fiber Bragg grating 5, via a fiber connector.

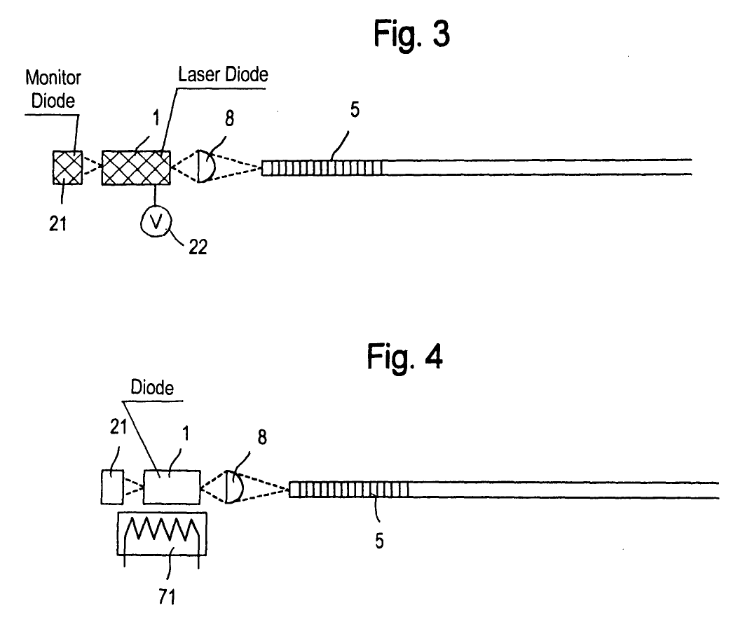

FIG. 3 shows, schematically, two possible ways to measure the photon density in the optical resonator. One possibility, as has already been explained with reference to FIG. 2, is to provide a monitor diode 21. The other possibility is to measure the voltage across the laser diode 1 when the laser operating current is constant. This is illustrated by a schematically illustrated tap 22 for measurement of the voltage across the laser diode 1.

FIG. 8 shows the relationship between the current through the monitor diode 21 and the wavelength. This shows that the monitor diode current has a maximum at the central wavelength λ_{BRAGG}. This is quite reasonable since, as is shown in FIG. 7, the reflection level of the fiber Bragg grating is at its greatest at the central wavelength λ_{BRAGG}. However, the Q-factor of the laser depends on the effective reflection of the fiber Bragg grating, that is to say the closer the laser line becomes spectrally to the central wavelength of the fiber Bragg grating, the higher the photon density within the resonator. In a corresponding way, most light energy is emitted from the higher reflective layer 102 (see FIG. 2) at the central wavelength.

The photon density can thus be determined via the monitor diode current in the control loop explained in FIG. 1. The measurement apparatus 2 is in this case the monitor diode 21, and the output from the monitor diode 21 is supplied to the control device 6.

FIG. 10 shows the voltage on the laser diode as a function of the wavelength. FIG. 10 in this case shows that the voltage has a minimum at the central wavelength λ_{BRAGG}. This is thus due to the fact that most photons are located within the optical resonator at the central wavelength. This assists further stimulated emission. More electrons can thus pass through the pn junction of the laser diode when the light intensity is higher for the same voltage. The intrinsic resistance of the semiconductor laser is thus reduced as the light intensity in the resonator increases. The voltage on the semiconductor laser can thus be used to indirectly deduce the photon density in the resonator during constant laser operation.

When measuring the laser diode voltage, the corresponding measurement apparatus 22 represents the measurement apparatus 2 in the control loop in FIG. 1. The measured voltage value is supplied to the control apparatus 6. The controlled variable (in this case: the difference between two voltages for different effective optical path lengths of the resonator) is in this case regulated at a minimum.

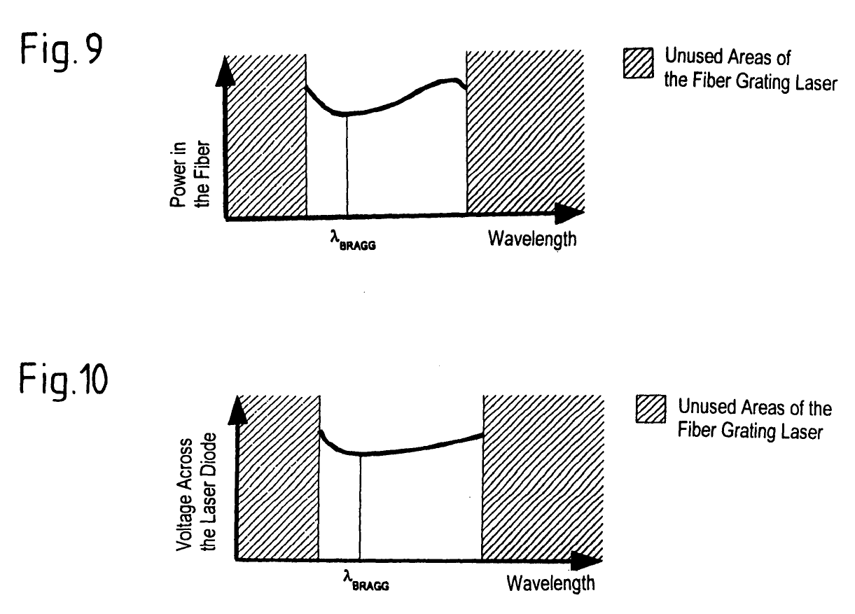

A further possible way to measure the photon density in the optical resonator can be seen from the illustration in FIG. 9. FIG. 9 shows the light power that is input into the optical waveguide 4 as a function of the wavelength. In order to explain the illustrated curve profile, it should be remembered that, as stated above, the photon density within the resonator is at a maximum at the central wavelength λ_{BRAGG}. However, the light also has to pass through the fiber Bragg grating 5 in order to reach the fiber 4. The closer the laser line is located to the central wavelength of the fiber Bragg grating 5, the less is the transmission of the output mirror and the less is the amount of light that can be output. These two effects counter one another and result in a power spectrum which, when plotted against the wavelength as shown in FIG. 9, has a maximum and a minimum. The minimum is in this case located at the central wavelength λ_{BRAGG}.

If the power that is input into the optical fiber 4 is monitored, for example via an optical splitter (which is not shown) and an associated monitor diode, then a monitor diode such as this would represent the measurement apparatus 2 shown in FIG. 1, and the monitor diode signal would be supplied to the control apparatus 6. The regulation process would in this case be carried out by regulating the controlled variable (in this case the difference in the monitor current in the corresponding monitor diode) at zero, in which case another necessary condition is for the monitor current to be a minimum.

FIGS. 2 and 3 as well as 8 to 10 have been used to explain how the photon density in the optical resonator can be measured in various ways.

The description relating to FIGS. 4 to 6, which now follows, relates to various refinements of the adjustment apparatus for adjustment of the effective optical path length of the optical resonator.

As is shown in FIG. 4, the adjustment apparatus is in the form of a thermal regulating device 71: i.e., a heating or cooling element 71. The apparatus 71 is in this case heated or cooled corresponding to the control commands from the control apparatus 6 in FIG. 1. The heating apparatus 71 regulates the temperature of the semiconductor diode 1. Since the refractive index of the active material of the semiconductor diode 1 is temperature-dependent, varying the temperature also changes the effective optical path length of the resonator.

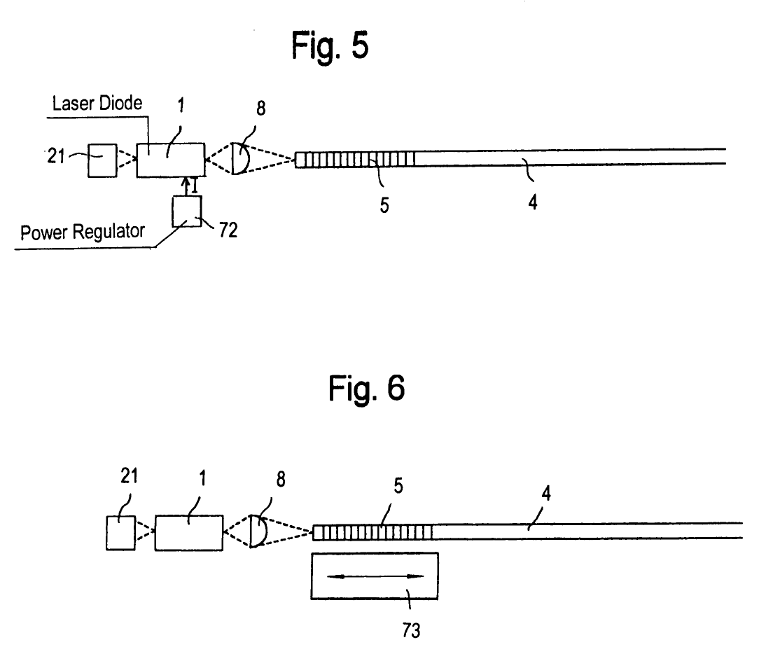

In the exemplary embodiment shown in FIG. 5, the effective optical path length of the optical resonator is adjusted by varying the operating current I through the semiconductor diode, which leads indirectly to heating or cooling of the semiconductor crystal and hence once again to a change in the effective optical path length. FIG. 5 shows a power regulator 72 which produces the operating current i for the laser diode 1. A power regulator such as this is always present in any case, and was not shown in the previous figures merely to assist clarity. The power regulator 72 receives from the control apparatus 6 in FIG. 1 control signals for adaptation to the operating current i through the laser diode.

The fluctuations of the operating current are in this case only within a limited range, so that on the one hand, the functionality of the semiconductor laser is always ensured and, on the other hand, no excessively high intensities are produced.

In the exemplary embodiment shown in FIG. 6, the adjustment apparatus is formed by an apparatus 73 that is connected to the optical fiber 4 and allows slight movement of the optical fiber, and hence also of the fiber Bragg grating 5, along the optical axis of the optical resonator. In this refinement, the effective optical path length of the resonator is varied by changing the geometric distance between the two mirror surfaces of the resonator.

The described method for wavelength stabilization is carried out iteratively during the time in which the laser is being operated, so that the laser line can differ from the central wavelength λ_{BRAGG} of the Bragg grating only to the extent that the respectively used control of the wavelength of the laser line allows. The invention thus once again compensates for fluctuations in the wavelength, particularly those caused by ageing of the laser chip, over the course of the time in which the laser is operated. This also compensates not only for changes in the ambient temperature, but also for changes in the operating temperature.

Without the described wavelength stabilization, the spectral position of the wavelength (laser line) thus migrates as the operating conditions change until the area used by the fiber grating is left (see FIG. 7). At these limits, the laser runs in a stable manner only to a limited extent. The laser either ceases to function or changes its load line, that is to say a sudden mode change occurs. Changes to the operating conditions include not only ageing but also, in particular, a change to the operating current and a change to the operating temperature. A further example of changes to the operating conditions is mechanical stresses that are applied to the laser diode.

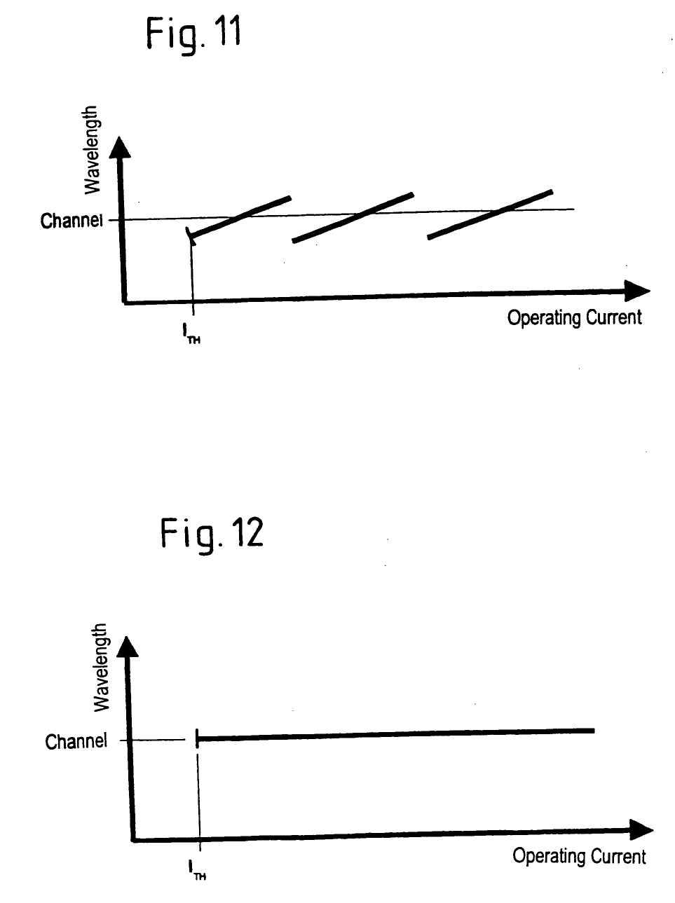

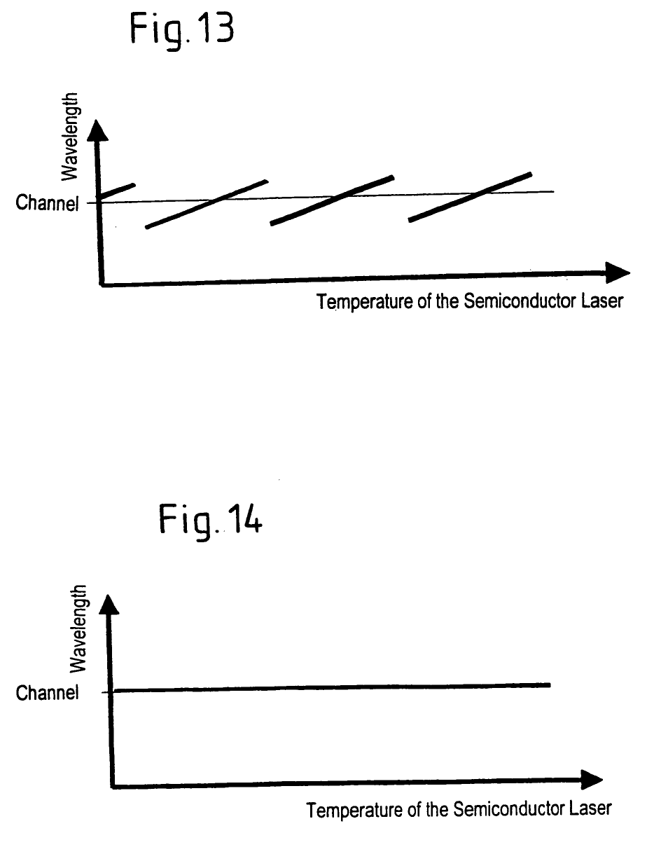

FIGS. 11 to 13 illustrate how the output wavelength varies as a function of the operating current of the temperature of the semiconductor laser without wavelength stabilization. The discontinuities illustrated in FIGS. 11 and 13 correspond to areas in which the output wavelength leaves the spectral extent Δλ on the fiber Bragg grating and a sudden mode change in consequence occurs, with the laser operating at a different wavelength.

FIGS. 12 and 14 show the output wavelength as a function of the temperature of the semiconductor laser and of the operating current with wavelength stabilization according to the invention as shown in FIG. 1. The output wavelength is constant. A fixed wavelength channel is thus provided, as is specified by the ITU recommendations for WDM, DWDM, and CWDM systems.

We claim:

1. A laser module for optical transmission systems, comprising:
a laser diode emitting light at an emitted output wavelength;
an optical resonator connected to said laser diode and having a reflective mirror surface and an adjustable effective optical path length and a photon density as a function of the effective optical path length;
an optical waveguide having a Bragg grating receiving the light from said laser diode; and
a stabilizer stabilizing the emitted output wavelength and having:
a measurement apparatus for measuring the photon density within said resonator,
an adjustment apparatus for adjusting the effective optical path length of said resonator, and
a control apparatus comparing the photon density at different effective optical path lengths of said resonator and producing control commands to said adjustment apparatus in order to adjust the effective optical path length of said resonator to equal the emitted output wavelength to a desired wavelength.

2. The laser module according to claim 1, wherein said reflective mirror surface of said optical resonator is highly reflective.

3. The laser module according to claim 1, wherein said adjustment apparatus has a device for longitudinal movement of said optical waveguide.

4. The laser module according to claim 1, wherein said adjustment apparatus has a thermal regulating device for said laser diode.

5. The laser module according to claim 4, wherein said thermal regulating device heats said laser diode.

6. The laser module according to claim 4, wherein said thermal regulating device cools said laser diode.

7. The laser module according to claim 1, wherein said adjustment apparatus has a device for varying an operating current of said laser diode.

8. The laser module according to claim 1, wherein said measurement apparatus has a monitor diode disposed adjacent said highly reflective mirror surface of said optical resonator and detecting light output from said resonator by said mirror surface.

9. The laser module according to claim 1, wherein said measurement apparatus has a detector for detecting a voltage across said laser diode when a laser operating current is constant.

10. The laser module according to claim 1, wherein said control apparatus is part of a control loop regulating the emitted output wavelength of the laser module at the desired wavelength, with the photon density being measured iteratively and said control apparatus emitting a control command to said adjustment apparatus for adjusting the effective optical path length of said resonator based on a difference between two successive measurements.

11. The laser module according to claim 1, wherein said laser diode forms a Fabry-Perot semiconductor laser having a facet formed by said highly reflective mirror surface of said optical resonator.

12. The laser module according to claim 11, wherein said Fabry-Perot semiconductor laser has a front facet coated with an antireflective coating, said Fabry-Perot semiconductor laser sending light from said antireflective coating to said Bragg grating.

13. The laser module according to claim 1, wherein:
said Bragg grating has a central wavelength; and
said control apparatus controls said adjustment apparatus to approach the emitted output wavelength to the central wavelength of said Bragg grating.

14. The laser module according to claim 1, wherein:
said Bragg grating has a central wavelength; and
said control apparatus controls said adjustment apparatus to equal the emitted output wavelength to the central wavelength of said Bragg grating.

15. The laser diode according to claim 1, further comprising coupling optics coupling said laser diode to said Bragg grating.

16. The laser diode according to claim 15, wherein said coupling optics is a lens selected from the group consisting of a silicon lens, a spherical lens, an aspherical lens, and a graded index lens composed of a suitable optical material.

17. The laser module according to claim 15, wherein said coupling optics have an antireflection coating.

18. The laser module according to claim 16, wherein said coupling optics are slightly inclined.

19. The laser module according to claim 1, wherein said optical waveguide is a single-mode glass fiber.

20. The laser module according to claim 19, wherein:
said glass fiber has an end; and
said end of said glass fiber has an antireflection coating.

21. The laser module according to claim 19, wherein:
said glass fiber has an end; and
said end of said glass fiber is slightly inclined.

22. The laser module according to claim 1, wherein said Bragg grating is immediately adjacent said laser diode.

23. The laser module according to claim 1, wherein said control apparatus emits a control command to said adjustment apparatus to change the effective optical path length of said resonator by a predetermined fixed amount.

24. The laser module according to claims 1, wherein said control apparatus emits a control command to said adjustment apparatus based on an internal calculation to change the effective optical path length of said resonator by an amount depending on a comparison between different values of the photon density at different optical path lengths of said resonator.

25. A method for stabilizing an output wavelength of a laser module for optical transmission systems, which comprises:
a) providing a laser module including a laser diode emitting light at an emitted output wavelength, an optical resonator connected to the laser diode and having a reflective mirror surface and an adjustable effective optical path length and a photon density as a function of the effective optical path length, an optical waveguide having a Bragg grating receiving the light from the laser diode;
b) measuring the photon density within the resonator at a first effective optical path length of the resonator;
c) changing the effective optical path length of the resonator;
d) measuring the photon density within the resonator at a second effective optical path length of the resonator;
e) comparing the two measured photo densities;
f) adjusting the effective optical path length of the resonator based on the comparing step, with the effective optical path length of the resonator being changed depending on the comparing step; and
g) repeating steps b) to e) until the emitted output wavelength is equal to a desired wavelength.

26. The method according to claim 25, which further comprises repeating steps b) to f) regularly throughout a life of the laser module to calibrate the output wavelength.

27. The method according to claim 25, which further comprises repeating steps b) to e) until the emitted output wavelength equals a central wavelength of the Bragg grating.

28. The method according to claim 25, wherein the measuring of the photon density utilizes a monitor diode.

29. The method according to claim 25, wherein the measuring of the photon density utilizes a voltage dropped across the laser diode when a laser operating current is constant.

30. The method according to claim 25, wherein the effective optical path length of the resonator is adjusted by externally changing a temperature of the laser diode by at least one of varying an operating current of the laser diode and axially moving the optical waveguide.

31. The method according to claim 25, wherein the comparison of the measured photon densities is carried out by subtraction in step e).

32. The method according to claim 25, wherein the effective optical path length of the resonator is always changed by a predetermined value in step f).

33. The method according to claim 25, wherein the optical path length of the resonator is changed in step f) by an amount depending on the comparison of the measured photon densities in step e).

34. The method according to claim 25, which further comprises transmitting light in the resonator between the laser diode and the Bragg grating via coupling optics.
